(19) United States
(12) Patent Application Publication
(10) Pub. No.: US 2015/0380986 A1
(43) Pub. Date: Dec. 31, 2015

(54) UNINTERRUPTIBLE POWER SUPPLY SYSTEM

(71) Applicant: JUST POWER INTEGRATED TECHNOLOGY INC., New Taipei City (TW)

(72) Inventor: Ching-Nan Yang, New Taipei City (TW)

(21) Appl. No.: 14/316,818

(22) Filed: Jun. 27, 2014

(51) Int. Cl. H02J 9/06

(52) U.S. Cl. CPC H02J 9/065

(57) ABSTRACT

The system contains a first operation module connected to AC mains and a second operation module connected to a lighting device. The first operation module contains an activation switch, a first electricity detection unit, and a wireless transmitter. The second operation module contains a second electricity detection unit, a reset switch, and a wireless receiver. The first and second operation modules communicate through the wireless transmitter and receiver. When electricity provision is normal, the second operation module plays a dominant role in a wired mode. When the activation switch is engaged, the second operation module releases the dominant role to the first operation module, where the uninterruptible power supply system enters a wireless mode. To switch back to the wired mode, the second operation module is reset by the reset switch. The uninterruptible power supply system as such can be freely alternated between the wired and wireless modes.

### BACKGROUND OF INVENTION

(a) Technical Field of the Invention

The present invention is generally related to uninterruptible power supply, and more particular to an uninterruptible power supply system that switches between two modes of operation.

(b) Description of the Prior Art

Emergency lighting apparatus provides appropriate illumination in the household, in a working environment, or to an emergency exit when normal power provision is interrupted when an emergency condition occurs. People therefore can properly finish their work or safely escape.

Commercially available emergency lighting apparatus is usually installed around the exits or passage corners so that people can find their way out when normal lighting is unavailable due to power interruption.

This type of emergency lighting apparatus has built-in automatic AC-DC switching device and a rechargeable battery as a standby power source. When power provision is normal, the battery is charged by the AC mains until the battery is full and then the charging automatically stops. When the power provision is interrupted, the AC-DC switching device automatically switches to use the battery to power the emergency lighting apparatus. The switching is usually achieved either in a wired more or in a wireless mode, but not both, thereby limiting the applicability of the emergency lighting apparatus.

### SUMMARY OF THE INVENTION

An uninterruptible power supply system according to the present invention contains a first operation module and a second operation module. The first operation module is electrically connected to AC mains and contains an activation switch, a first electricity detection unit, and a wireless transmitter.

The second operation module is electrically connected to a lighting device and contains a second electricity detection unit, a reset switch, and a wireless receiver. The first and second operation modules communicate with each other through the signally linked wireless transmitter and receiver. When the activation switch is engaged, the wireless transmitter sends a signal to the wireless receiver, which triggers the second operation module to release a dominant role to the first operation module, where the uninterruptible power supply system enters a wireless mode. To switch from the wireless mode to the wired mode, the reset switch is engaged to reset the second operation module and as such the first operation module releases the dominant role back to the second operation module. Through the above configuration, the uninterruptible power supply system integrates the wired and wireless modes, and can be freely alternated between the wired mode and the wireless mode.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing an uninterruptible power supply system according to an embodiment of the present invention.

FIG. 2 shows an application scenario of the uninterruptible power supply system of FIG. 1 in a wired mode.

FIG. 3 shows an application scenario of the uninterruptible power supply system of FIG. 1 in a wireless mode.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

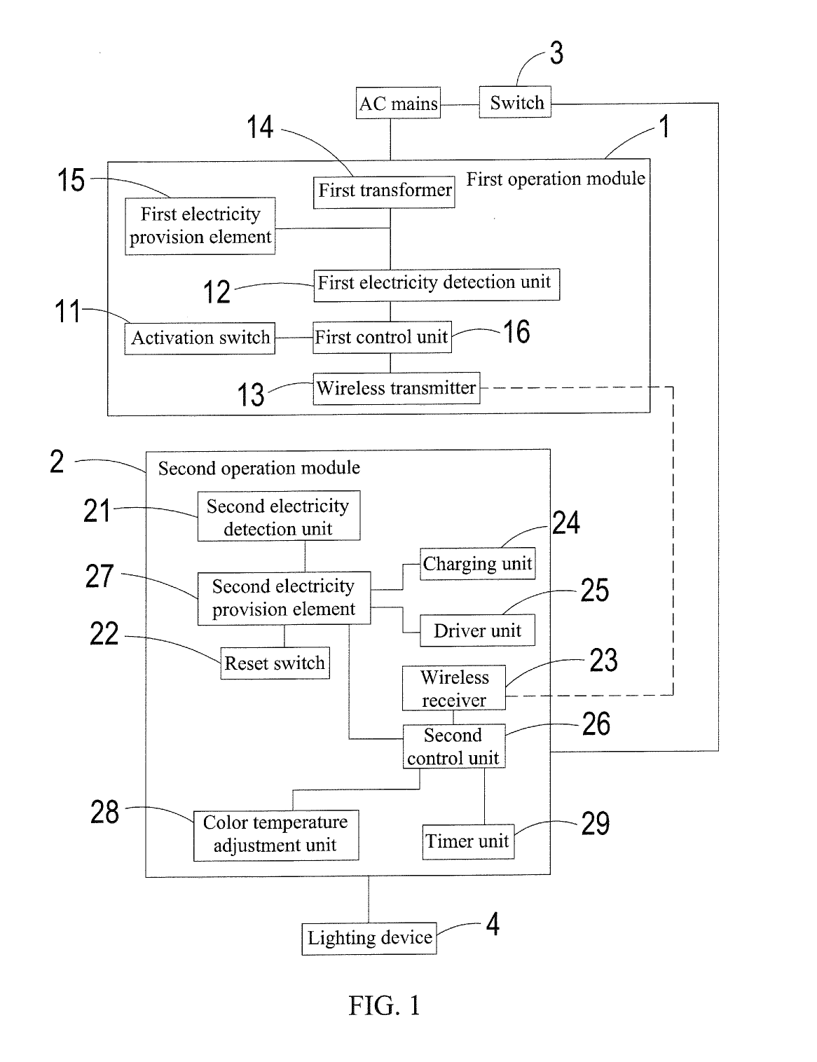

As shown in FIG. 1, an uninterruptible power supply system according to the present invention contains a first operation module 1 electrically connected to AC mains. The first operation module 1 contains an activation switch 11, a first electricity detection unit 12, and a wireless transmitter 13.

The uninterruptible power supply system also contains a second operation module 2 electrically connected to a lighting device 4. The second operation module 2 contains a second electricity detection unit 21, a reset switch 22, and a wireless receiver 23. The first and second operation modules 1 and 2 communicate with each other through the signally linked wireless transmitter and receiver 13 and 23 so that the first and second operation modules 1 and 2 can alternately assume a dominant role of the uninterruptible power supply system.

The first operation module 1 further contains a first transformer 14, a first electricity provision element 15, and a first control unit 16. The first transformer 14 is electrically connected with the first electricity provision element 15 and the first electricity detection unit 12. The first electricity detection unit 12 is data-linked with the first control unit 16. The first control unit 16 is engaged by the activation switch 11, and the wireless transmitter 13 is engaged by the first control unit 16.

The second operation module 2 further contains a charging unit 24, a driver unit 25, a second control unit 26, and a second electricity provision element 27. The charging unit 24 is electrically connected with the second electricity provision element 27 and the second electricity detection unit 21. The second electricity provision element 27 engages the driver unit 25 which is also engaged by the second control unit 26 and the second electricity detection unit 21.

A switch 3 is series-connected between the second operation module 2 and the AC mains. The lighting device 4 can be a halogen lamp, an incandescent lamp, a fluorescent lamp, or a lamp using light emitting diode (LED) as light source.

The second operation module 2 further contains a color temperature adjustment unit 28 and a timer unit 29. The color temperature adjustment unit 28 controls the color temperature of the lighting device 4 to be between 2300 K˜3500 K.

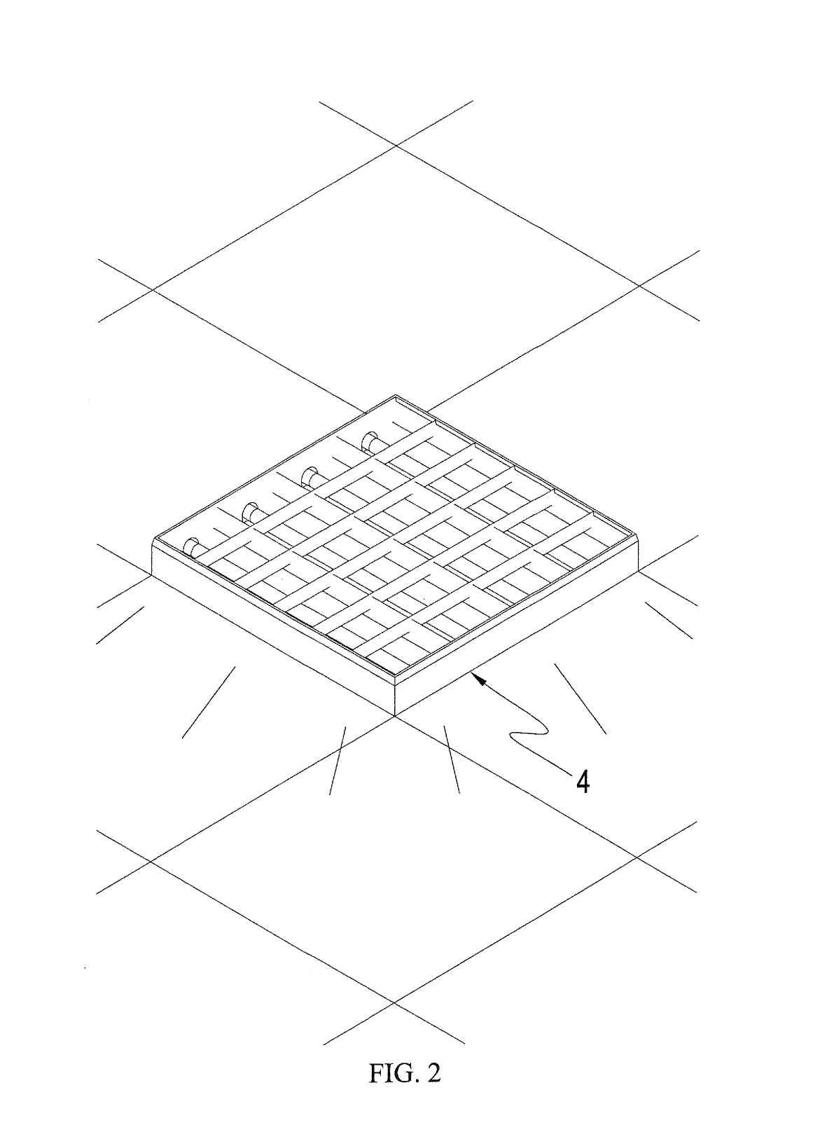

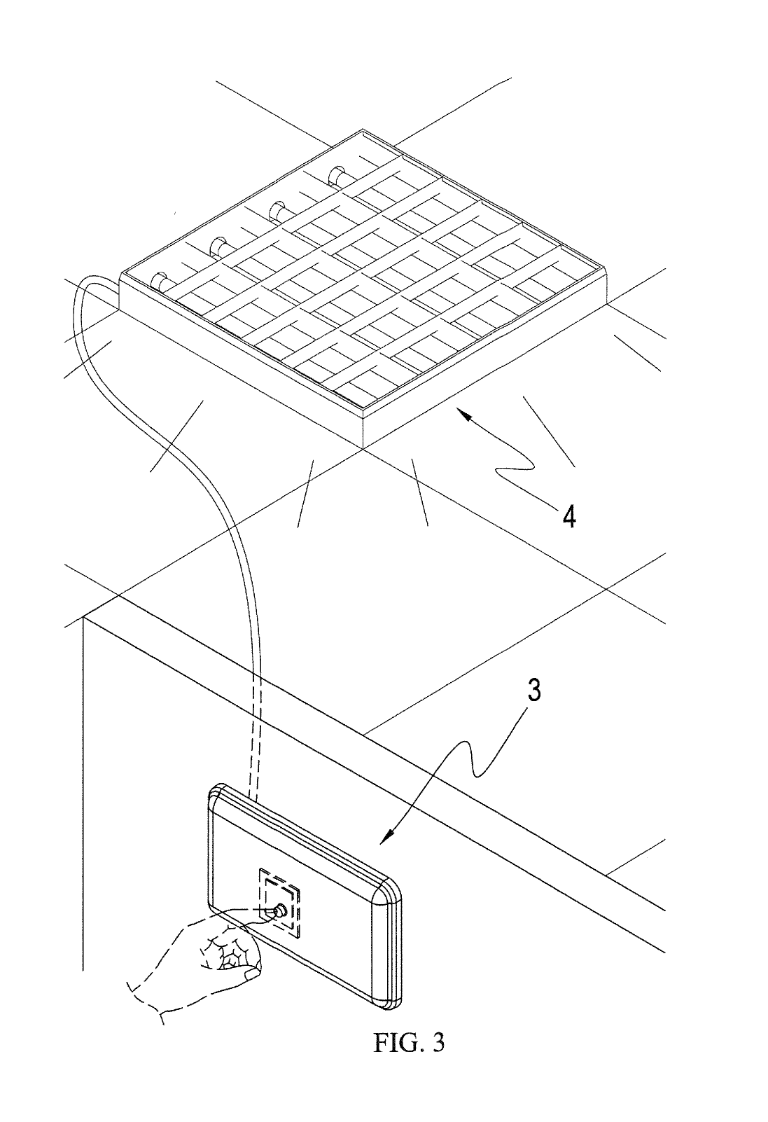

As shown in FIGS. 1 to 3, the uninterruptable power supply system provides two operation modes: a wired mode and a wireless mode. The wired mode is for applications that the lighting device 4 is always turned on (i.e., the switch 3 is always kept at an ON state). Under this mode, the second operation module 2 plays a dominant role. The second electricity detection unit 21 detects whether electricity provision from AC mains is normal. If it is normal, the electricity is used to charge the second electricity provision element 27 by the charging unit 24. In the meantime, the driver unit 25 drives the lighting device 4 to produce illumination. If there is black out or the electricity provision from AC mains is interrupted, the second electricity detection unit 21 notifies the second control unit 26 to switch to let the second electricity provision element 27 to power the lighting device 4. On the other hand, the wireless mode is for applications that the lighting device 4 can be turned on or off (i.e., the lighting device 4 is turned on when the switch 3 is at the ON state, and the lighting device 4 is turned off when the switch is at an OFF state). Under this mode, the first operation module 1 plays the dominant role. The first control unit 16 is engaged by the activation switch 11. Then, the first control unit 16 triggers the wireless transmitter 13 to send a signal to the wireless receiver 23, which in turn triggers the second control unit 26 and as such the second operation module 2 releases the dominant role to the first operation module 1 (i.e., the wireless mode). The first electricity detection unit 12 detects whether electricity provision from AC mains is normal. If it is normal, the electricity is used to charge the first electricity provision element 15 by the first transformer 14, and the electricity from AC mains directly powers the second operation module 2. In the meantime, if the switch 3 is at the ON state, the lighting device 4 is turned on whereas, if the switch 3 is at the OFF state, the lighting device 4 is turned off. If there is black out or the electricity provision from AC mains is interrupted, the first electricity detection unit 12 switches to let the first electricity provision element 15 to power the first operation module 1. The first control unit 16 triggers the wireless transmitter 13 to send a power loss signal to the wireless receiver 23, which in turn triggers the second control unit 26 to switch to let the second electricity provision element 27 to power the lighting device 4. To switch from the wireless mode to the wired mode, the reset switch 22 is engaged to reset the second control unit 26 and as such the first operation module 1 releases the dominant role back to the second operation module 2. When there is black out or the electricity provision from AC mains is interrupted, and if the lighting device 4 is capable of color temperature adjustment, the color temperature adjustment unit 28 sets the color temperature of the lighting device to be between 2300 K˜3500 K for emergency lighting. On the other hand, when emergency lighting is activated, the timer unit 29 can automatically turn on or off the emergency lighting at preset time instances.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An uninterruptible power supply system, comprising:
a first operation module electrically connected to AC mains, the first operation module comprising an activation switch, a first electricity detection unit, and a wireless transmitter; and
a second operation module comprising a second electricity detection unit, a reset switch, and a wireless receiver;
wherein the first and second operation modules communicate with each other through signally linked wireless transmitter and receiver;
when the activation switch is engaged, the wireless transmitter sends a signal to the wireless receiver, which triggers the second operation module to release a dominant role to the first operation module; and
when the reset switch is engaged, the second operation module is reset and the first operation module releases the dominant role back to the second operation module.

2. The uninterruptible power supply system according to claim 1, wherein the first operation module further comprises a first transformer, a first electricity provision element, and a first control unit; the first transformer is electrically connected with the first electricity provision element and the first electricity detection unit; the first electricity detection unit is data-linked with the first control unit; the first control unit is engaged by the activation switch; and the wireless transmitter is engaged by the first control unit.

3. The uninterruptible power supply system according to claim 1, wherein the second operation module further comprises a charging unit, a driver unit, a second control unit, and a second electricity provision element; the charging unit is electrically connected with the second electricity provision element and the second electricity detection unit; the second electricity provision element engages the driver unit; and the driver unit is also engaged by the second control unit and the second electricity detection unit.

4. The uninterruptible power supply system according to claim 1, further comprising a switch series-connected between the first and second operation modules.

5. The uninterruptible power supply system according to claim 1, wherein the second operation module is electrically connected to a lighting device.

6. The uninterruptible power supply system according to claim 5, wherein the lighting device is one of a halogen lamp, an incandescent lamp, a fluorescent lamp, and a lamp using light emitting diode (LED) as light source.

7. The uninterruptible power supply system according to claim 1, wherein the second operation module further comprises a color temperature adjustment module.

8. The uninterruptible power supply system according to claim 7, wherein the color temperature adjustment module controls a color temperature of the lighting device to be between 2300 K˜3500 K.

9. The uninterruptible power supply system according to claim 1, wherein the second operation module further comprises a timer unit.
